(19) United States
(12) Patent Application Publication
(10) Pub. No.: US 2023/0280637 A1
(43) Pub. Date: Sep. 7, 2023

(54) CAMERA DEVICE WITH TWO-STAGE ACTUATORS AND CAMERA DEVICE PACKAGING USING SANDWICH MOLDING TECHNIQUE

(71) Applicant: Meta Platforms Technologies, LLC, Menlo Park, CA (US)

(72) Inventors: Vijay Kumar, Fremont, CA (US); Lidu Huang, Danville, CA (US); Samuel Tam, Daly City, CA (US)

(21) Appl. No.: 18/195,846

(22) Filed: May 10, 2023

Related U.S. Application Data
(60) Provisional application No. 63/347,383, filed on May 31, 2022.
(60) Provisional application No. 63/347,385, filed on May 31, 2022.

(51) Int. Cl. G03B 13/36; H02K 41/035; H04N 23/50

(52) U.S. Cl. CPC G03B 13/36; H02K 41/0354; H04N 23/50; G03B 30/00

(57) ABSTRACT

A camera device for integration into an electronic wearable device. The camera device includes a lens assembly, an image sensor, a first actuator assembly, and a second actuator assembly. The first actuator assembly translates the lens assembly over a first range along an optical axis, wherein power consumed by the first actuator assembly increases with a distance the lens assembly is actuated along the optical axis from a neutral position of the lens assembly. The second actuator assembly translates the image sensor over a second range along the optical axis, wherein the second range is smaller than the first range. A method of packaging the camera device is further presented where a molded plastic layer is sandwiched between a first high density interconnect (HDI) tape substrate and a second HDI tape substrate. The molded plastic layer includes vias to interconnect electrodes of the first and second HDI tape substrates.

### CROSS REFERENCE TO RELATED APPLICATIONS

This application claims a priority and benefit to U.S. Provisional Patent Application Ser. No. 63/347,383, filed May 31, 2022, and U.S. Provisional Patent Application Ser. No. 63/347,385, filed May 31, 2022, each of which is hereby incorporated by reference in its entirety.

### FIELD OF THE INVENTION

The present disclosure relates generally to cameras and camera packaging, and specifically relates to a camera device with two stage autofocus and camera device packaging using a sandwich molding technique.

### BACKGROUND

Conventional autofocus (AF) cameras use a single actuator to adjust a distance between a lens and an image sensor. Commonly the single actuator is a voice coil motor (VCM). VCMs are a well-known technology but consume power to actuate over a long range. While this energy expenditure can be trivial for large form factor devices—it becomes increasingly important as one moves toward small form factor designs which generally have restrictive power budgets.

Cameras for wearable devices have increasingly small form factors. However, camera modules that are small in size, inexpensive to manufacture, and durable and reliable in operation, are very difficult to achieve.

### SUMMARY

Embodiments of the present disclosure relate to a camera device (e.g., wearable camera device) with two stage autofocus. The camera device includes a lens assembly configured to translate along an optical axis, an image sensor, a first actuator assembly, and a second actuator assembly. The first actuator assembly is configured to translate the lens assembly over a first range along the optical axis, wherein power consumed by the first actuator assembly increases with a distance the lens assembly is actuated along the optical axis from a neutral position of the lens assembly. The second actuator assembly is configured to translate the image sensor over a second range along the optical axis, wherein the second range is smaller than the first range.

Embodiments of the present disclosure further relate to a method of operating a camera device with two stage autofocus. The method comprises: applying first power to a first actuator assembly of a camera device to translate a lens assembly of the camera device over a first range along an optical axis of the lens assembly, wherein the first power consumed by the first actuator assembly increases with a distance the lens assembly is actuated along the optical axis from a neutral position of the lens assembly; and applying second power to a second actuator assembly of the camera device to translate an image sensor of the camera device over a second range along the optical axis, wherein the second range is smaller than the first range, and the second actuator assembly is more power efficient than the first actuator assembly.

Embodiments of the present disclosure are further directed to packaging of a camera device (e.g., wearable camera device). The camera device includes an image sensor, a lens assembly configured to hold at least one lens, a first high density interconnect (HDI) tape substrate, a second HDI tape substrate, and a molded plastic layer. The first HDI tape substrate has a top surface and a bottom surface. The top surface of the first HDI tape substrate is coupled to the lens assembly. The first HDI tape substrate is coupled to the image sensor, and the first HDI tape substrate includes a first plurality of electrodes. The second HDI tape substrate includes a second plurality of electrodes and a plurality of components mounted on a top surface of the second HDI tape substrate. The molded plastic layer is sandwiched between the bottom surface of the first HDI tape substrate and the top surface of the second HDI tape substrate. The molded plastic layer includes one or more vias to interconnect at least one electrode of the first plurality of electrodes to at least one electrode of the second plurality of electrodes.

The camera device presented herein may be part of a wristband system, e.g., a smartwatch or some other electronic wearable device. Additionally or alternatively, the camera device may be part of a handheld electronic device (e.g., smartphone) or some other portable electronic device.

### BRIEF DESCRIPTION OF THE DRAWINGS

FIG. 1A is a top view of an example wristband system, in accordance with one or more embodiments.

FIG. 1B is a side view of the example wristband system of FIG. 1A.

FIG. 2A is a perspective view of another example wristband system, in accordance with one or more embodiments.

FIG. 2B is a perspective view of the example wristband system of FIG. 2A with a watch body released from a watch band, in accordance with one or more embodiments.

FIG. 3 is a cross section of a camera device with single stage autofocus, in accordance with one or more embodiments.

FIG. 4 is a cross section of a camera device with two stage autofocus, in accordance with one or more embodiments.

FIG. 5 is a flowchart illustrating a process of operating a camera device with two stage autofocus, in accordance with one or more embodiments.

FIG. 6 illustrates an example process of packaging a camera device, in accordance with one or more embodiments.

FIG. 7A illustrates an example expanded view of the camera device packaged using the process in FIG. 6.

FIG. 7B illustrates another example expanded view of the camera device produced during the process in FIG. 6.

FIG. 8A is a cross section of an example structure of a camera device with an image sensor located on a top surface of a substrate, in accordance with one or more embodiments.

FIG. 8B is a cross section of an example structure of a camera device with an image sensor located within a cavity, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

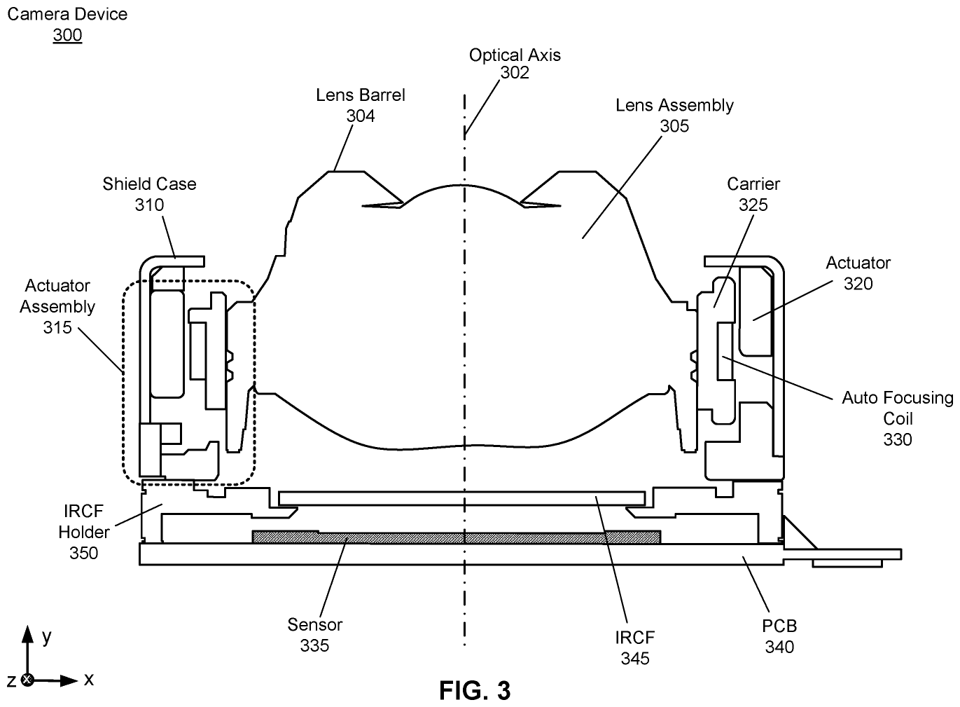

Embodiments of the present disclosure are directed to a camera device that includes a two stage auto focus (AF) actuator. The camera device may be integrated into an electronic wearable device (e.g., smartwatch, headset, etc.). The camera device includes a lens assembly, an image sensor, a first actuator assembly, and a second actuator assembly. The first actuator assembly (e.g., voice coil motor (VCM) based) may be configured to adjust a position of the lens assembly (e.g., for AF). The second actuator assembly (e.g., a microelectromechanical system (MEMS), shape memory alloy (SMA), etc.) may be configured to adjust a position of the image sensor (e.g., for AF, and optical image stabilization (OIS)). The first actuator assembly may be more power intensive than the second actuator assembly. By using the first actuator assembly in combination with the second actuator assembly, a total stroke length of the VCM may be reduced relative to conventional cases that only use a VCM, thereby resulting in significant power savings. Details about the camera device that includes a two stage AF actuator are provided in relation to FIGS. 3 through 5.

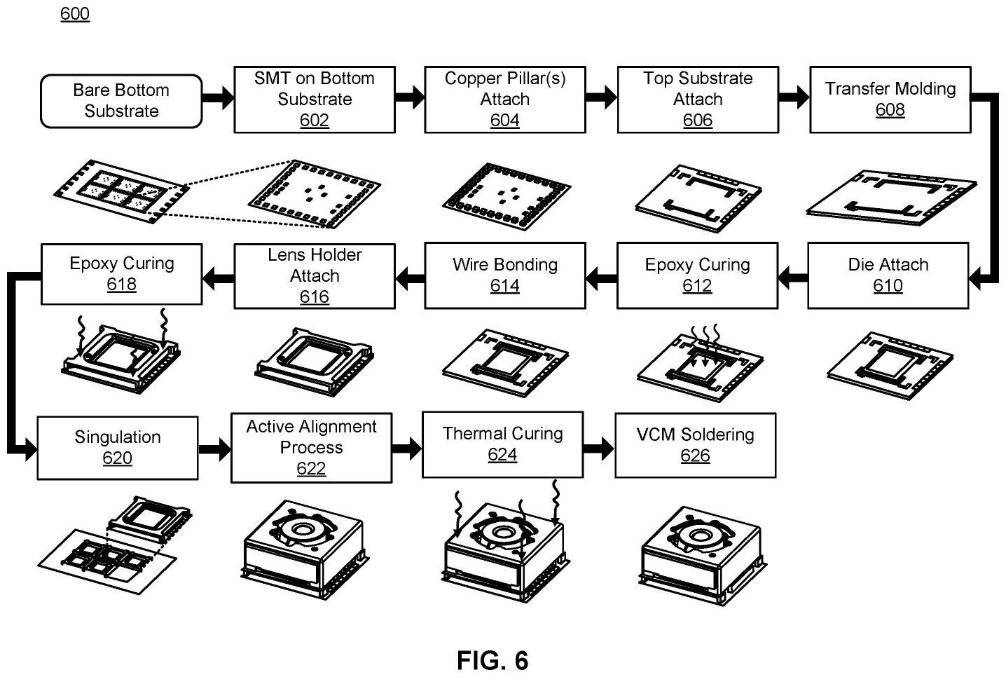

A camera device for integration into an electronic wearable device can be packaged using a process presented in this disclosure. The process presented herein may populate different surface mount technology (SMT) components (e.g., passive devices, dummies, and interconnects) on a side of a first high density interface (HDI) tape substrate. The process may utilize one or more pillars within the first HDI tape substrate to make interconnections to a second HDI tape substrate. A transfer molding may be utilized to fill an encapsulant in between the first HDI tape substrate and the second HDI tape substrate. An image sensor may be positioned on the second HDI tape substrate (e.g., in a cavity of the second HDI tape substrate). Details about the process of packaging a camera device are provided in relation to FIGS. 6 through 8B.

The camera device presented herein may be incorporated into a small form factor electronic device, such as an electronic wearable device. Examples of electronic wearable devices include a smartwatch or a headset. The electronic device can include other components (e.g., haptic devices, speakers, etc.). And, the small form factor of the electronic device provides limited space between the other components and the camera device. In some embodiments, the electronic device may have limited power supply (e.g., due to being dependent on a re-chargeable battery).

In some embodiments, the electronic wearable device may operate in an artificial reality environment (e.g., a virtual reality environment). The camera device of the electronic wearable device may be used to enhance an artificial reality application running on an artificial reality system (e.g., running on a headset worn by the user). The camera device may be disposed on multiple surfaces of the electronic wearable device such that data from a local area, e.g., surrounding a wrist of the user, may be captured in multiple directions. For example, one or more images may be captured describing the local area and the images may be sent and processed by the headset prior to be presented to the user.

Embodiments of the present disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including an electronic wearable device (e.g., headset) connected to a host computer system, a standalone electronic wearable device (e.g., headset, smartwatch, bracelet, etc.), a mobile device or computing system, or any other hardware platform capable of providing artificial reality content to one or more viewers.

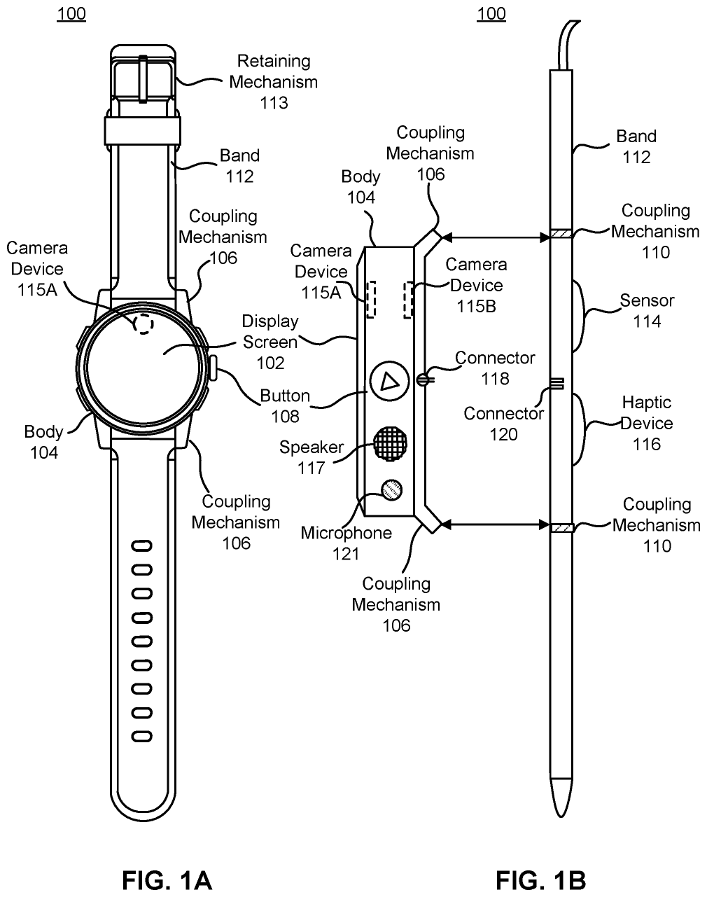

FIG. 1A is a top view of an example wristband system 100, in accordance with one or more embodiments. FIG. 1B is a side view of the example wristband system 100 of FIG. 1A. The wristband system 100 is an electronic wearable device and may be worn on a wrist or an arm of a user. In some embodiments, the wristband system 100 is a smartwatch. Media content may be presented to the user wearing the wristband system 100 using a display screen 102 and/or one or more speakers 117. However, the wristband system 100 may also be used such that media content is presented to a user in a different manner (e.g., via touch utilizing a haptic device 116). Examples of media content presented by the wristband system 100 include one or more images, video, audio, or some combination thereof. The wristband system 100 may operate in an artificial reality environment (e.g., a VR environment, an AR environment, a MR environment, or some combination thereof).

In some examples, the wristband system 100 may include multiple electronic devices (not shown) including, without limitation, a smartphone, a server, a head-mounted display (HMD), a laptop computer, a desktop computer, a gaming system, Internet of things devices, etc. Such electronic devices may communicate with the wristband system 100 (e.g., via a personal area network). The wristband system 100 may have sufficient processing capabilities (e.g., central processing unit (CPU), memory, bandwidth, battery power, etc.) to offload computing tasks from each of the multiple electronic devices to the wristband system 100. Additionally, or alternatively, each of the multiple electronic devices may have sufficient processing capabilities (e.g., CPU, memory, bandwidth, battery power, etc.) to offload computing tasks from the wristband system 100 to the electronic device(s).

The wristband system 100 includes a watch body 104 coupled to a watch band 112 via one or more coupling mechanisms 106, 110. The watch body 104 may include, among other components, one or more coupling mechanisms 106, one or more camera devices 115 (e.g., camera device 115A and 115B), the display screen 102, a button 108, a connector 118, a speaker 117, and a microphone 121. The watch band 112 may include, among other components, one or more coupling mechanisms 110, a retaining mechanism 113, one or more sensors 114, the haptic device 116, and a connector 120. While FIGS. 1A and 1B illustrate the components of the wristband system 100 in example locations on the wristband system 100, the components may be located elsewhere on the wristband system 100, on a peripheral electronic device paired with the wristband system 100, or some combination thereof. Similarly, there may be more or fewer components on the wristband system 100 than what is shown in FIGS. 1A and 1B. For example, in some embodiments, the watch body 104 may include a port for connecting the wristband system 100 to a peripheral electronic device and/or to a power source. The port may enable charging of a battery of the wristband system 100 and/or communication between the wristband system 100 and a peripheral device. In another example, the watch body 104 may include an inertial measurement unit (IMU) that measures a change in position, an orientation, and/or an acceleration of the wristband system 100. The IMU may include one or more sensors, such as one or more accelerometers, one or more gyroscopes, one or more magnetometers, another suitable type of sensor that detects motion, a type of sensor used for error correction of the IMU, or some combination thereof.

The watch body 104 and the watch band 112 may have any size and/or shape that is configured to allow a user to wear the wristband system 100 on a body part (e.g., a wrist). The wristband system 100 may include the retaining mechanism 113 (e.g., a buckle) for securing the watch band 112 to the wrist of the user. The coupling mechanism 106 of the watch body 104 and the coupling mechanism 110 of the watch band 112 may attach the watch body 104 to the watch band 112. For example, the coupling mechanism 106 may couple with the coupling mechanism 110 by sticking to, attaching to, fastening to, affixing to, some other suitable means for coupling to, or some combination thereof.

The wristband system 100 may perform various functions associated with the user. The functions may be executed independently in the watch body 104, independently in the watch band 112, and/or in communication between the watch body 104 and the watch band 112. In some embodiments, a user may select a function by interacting with the button 108 (e.g., by pushing, turning, etc.). In some embodiments, a user may select a function by interacting with the display screen 102. For example, the display screen 102 is a touchscreen and the user may select a particular function by touching the display screen 102. The functions executed by the wristband system 100 may include, without limitation, displaying visual content to the user (e.g., displaying visual content on the display screen 102), presenting audio content to the user (e.g., presenting audio content via the speaker 117), sensing user input (e.g., sensing a touch of button 108, sensing biometric data with the one or more sensors 114, sensing neuromuscular signals with the one or more sensors 114, etc.), capturing audio content (e.g., capturing audio with microphone 121), capturing data describing a local area (e.g., with a front-facing camera device 115A and/or a rear-facing camera device 115B), communicating wirelessly (e.g., via cellular, near field, Wi-Fi, personal area network, etc.), communicating via wire (e.g., via the port), determining location (e.g., sensing position data with a sensor 114), determining a change in position (e.g., sensing change(s) in position with an IMU), determining an orientation and/or acceleration (e.g., sensing orientation and/or acceleration data with an IMU), providing haptic feedback (e.g., with the haptic device 116), etc.

The display screen 102 may display visual content to the user. The displayed visual content may be oriented to the eye gaze of the user such that the content is easily viewed by the user. Traditional displays on wristband systems may orient the visual content in a static manner such that when a user moves or rotates the wristband system, the content may remain in the same position relative to the wristband system causing difficulty for the user to view the content. The displayed visual content may be oriented (e.g., rotated, flipped, stretched, etc.) such that the displayed content remains in substantially the same orientation relative to the eye gaze of the user (e.g., the direction in which the user is looking). The displayed visual content may also be modified based on the eye gaze of the user. For example, in order to reduce the power consumption of the wristband system 100, the display screen 102 may dim the brightness of the displayed visual content, pause the displaying of visual content, or power down the display screen 102 when it is determined that the user is not looking at the display screen 102. In some examples, one or more sensors 114 of the wristband system 100 may determine an orientation of the display screen 102 relative to an eye gaze direction of the user.

The position, orientation, and/or motion of eyes of the user may be measured in a variety of ways, including through the use of optical-based eye-tracking techniques, infrared-based eye-tracking techniques, etc. For example, the front-facing camera device 115A and/or rear-facing camera device 115B may capture data (e.g., visible light, infrared light, etc.) of the local area surrounding the wristband system 100 including the eyes of the user. The captured data may be processed by a controller (not shown) internal to the wristband system 100, a controller external to and in communication with the wristband system 100 (e.g., a controller of an HMD), or a combination thereof to determine the eye gaze direction of the user. The display screen 102 may receive the determined eye gaze direction and orient the displayed content based on the eye gaze direction of the user.

In some embodiments, the watch body 104 may be communicatively coupled to an HMD. The front-facing camera device 115A and/or the rear-facing camera device 115B may capture data describing the local area, such as one or more wide-angle images of the local area surrounding the front-facing camera device 115A and/or the rear-facing camera device 115B. The wide-angle images may include hemispherical images (e.g., at least hemispherical, substantially spherical, etc.), 180-degree images, 360-degree area images, panoramic images, ultra-wide area images, or a combination thereof In some examples, the front-facing camera device 115A and/or the rear-facing camera device 115B may be configured to capture images having a range between 45 degrees and 360 degrees. The captured data may be communicated to the HMD and displayed to the user on a display screen of the HMD worn by the user. In some examples, the captured data may be displayed to the user in conjunction with an artificial reality application. In some embodiments, images captured by the front-facing camera device 115A and/or the rear-facing camera device 115B may be processed before being displayed on the HMD. For example, certain features and/or objects (e.g., people, faces, devices, backgrounds, etc.) of the captured data may be subtracted, added, and/or enhanced before displaying on the HMD.

Components of the front-facing camera device 115A and the rear-facing camera device 115B may be capable of taking pictures capturing data describing the local area. A lens of the front-facing camera device 115A and/or a lens of the rear-facing camera device 115B can be automatically positioned at their target positions. A target position in a forward (or horizontal) posture of the front-facing camera device 115A may correspond to a position at which the lens of the front-facing camera device 115A is focused at a preferred focal distance (e.g., distance in the order of several decimeters). A target position in a forward (or horizontal) posture of the rear-facing camera device 115B may correspond to a position at which the lens of the rear-facing camera device 115B is focused at a hyperfocal distance in the local area (e.g., a distance of approximately 1.7 meter). An upward (vertical) posture of the front-facing camera device 115A (or the rear-facing camera device 115B) corresponds to a posture where an optical axis is substantially parallel to gravity. And a forward (horizontal) posture of the front-facing camera device 115A (or the rear-facing camera device 115B) corresponds to a posture when the optical axis is substantially orthogonal to gravity.

When the front-facing camera device 115A (and the rear-facing camera device 115B) changes its posture from, e.g., an upward posture to a forward posture, auto focusing and OIS may be applied by allowing a certain amount of shift (i.e., stroke) of a sensor and/or lens of the front-facing camera device 115A (and the rear-facing camera device 115B) along at least one spatial direction.

In accordance with embodiments of the present disclosure, the front-facing camera device 115A (and/or the rear-facing camera device 115B) uses two actuation stages for auto focusing. The front-facing camera device 115A (and/or the rear-facing camera device 115B) may include a first actuator assembly (e.g., VCM) for adjusting a position of a lens along the optical axis and a second actuator assembly (e.g., MEMS, SMA, etc.) for adjusting a position of the sensor along the optical axis. By using the first actuator assembly in combination with the second actuator assembly, a total stroke length of the first actuator assembly (e.g., VCM) may be reduced relative to conventional cases that only use a VCM, thereby resulting in significant power savings. More details about utilizing two actuation stages for auto focusing at the front-facing camera device 115A (and/or the rear-facing camera device 115B) are provided in relation to FIGS. 3 through 5.

In accordance with embodiments of the present disclosure, the front-facing camera device 115A (and/or the rear-facing camera device 115B) can be packaged using a process presented in this disclosure. The process may populate different SMT components on a side of a first HDI tape substrate, and utilize one or more pillars within the first HDI tape substrate to make interconnections to a second HDI tape substrate. A transfer molding may be utilized to fill an encapsulant in between the first HDI tape substrate and the second HDI tape substrate. An image sensor may be positioned on the second HDI tape substrate (e.g., in a cavity of the second HDI tape substrate). Details about the process of packaging the front-facing camera device 115A (and/or the rear-facing camera device 115B) are provided in relation to FIGS. 6 through 8B.

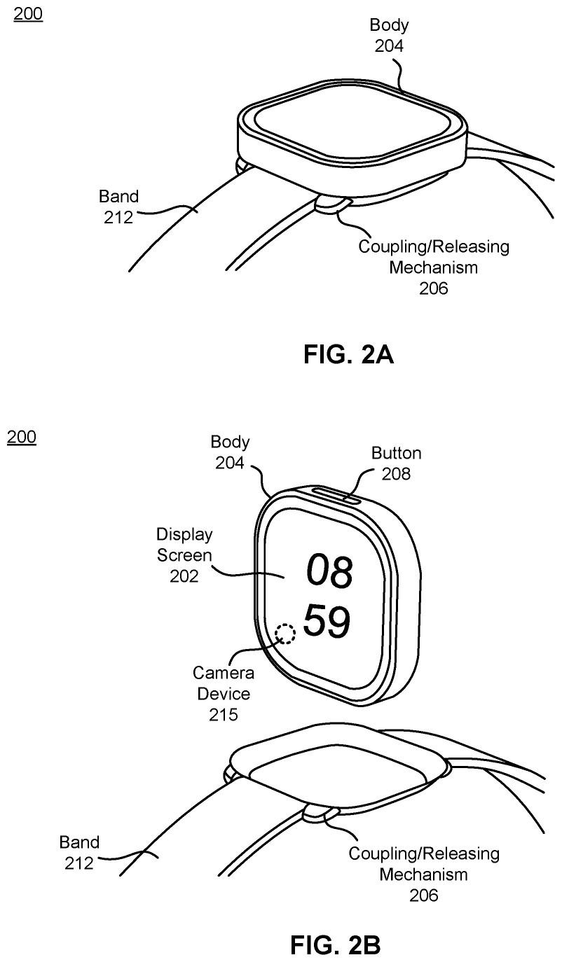

FIG. 2A is a perspective view of another example wristband system 200, in accordance with one or more embodiments. The wristband system 200 includes many of the same components described above with reference to FIGS. 1A and 1B, but a design or layout of the components may be modified to integrate with a different form factor. For example, the wristband system 200 includes a watch body 204 and a watch band 212 of different shapes and with different layouts of components compared to the watch body 104 and the watch band 112 of the wristband system 100. FIG. 2A further illustrates a coupling/releasing mechanism 206 for coupling/releasing the watch body 204 to/from the watch band 212.

FIG. 2B is a perspective view of the example wristband system 200 with the watch body 204 released from the watch band 212, in accordance with one or more embodiments. FIG. 2B further illustrates a camera device 215A, a display screen 202, and a button 208. In some embodiments, another camera device may be located on an underside of the watch body 204 and is not shown in FIG. 2B. In some embodiments (not shown in FIGS. 2A-2B), one or more sensors, a speaker, a microphone, a haptic device, a retaining mechanism, etc. may be included on the watch body 204 or the watch band 212. As the wristband system 100 and the wristband system 200 are of a small form factor to be easily and comfortably worn on a wrist of a user, the corresponding camera devices 115, 215 and various other components of the wristband system 100 and the wristband system 200 described above are designed to be of an even smaller form factor and are positioned close to each other.

When the camera device 215 changes its posture, e.g., from an upward posture to a forward posture, OIS and auto focusing may be applied by allowing a certain amount of shift (i.e., stroke) of a sensor and/or lens assembly of the camera device 215 along at least one spatial direction. Ranges of strokes may be asymmetric for the orthogonal spatial directions, i.e., an amount of shift along a first direction may be different than an amount of shift along a second direction orthogonal to the first direction. For example, a shifting range in a direction where more motion of the camera device 215 is expected (e.g., vertical direction) may be longer than a shifting range in the orthogonal direction (e.g., horizontal direction).

In accordance with embodiments of the present disclosure, the camera device 215 uses two actuation stages for auto focusing. The camera device 215 may include a first actuator assembly (e.g., VCM) for adjusting a position of a lens along the optical axis and a second actuator assembly (e.g., MEMS, SMA, etc.) for adjusting a position of the sensor along the optical axis. By using the first actuator assembly in combination with the second actuator assembly, a total stroke length of the first actuator assembly (e.g., VCM) may be reduced relative to conventional cases that only use a VCM, thereby resulting in significant power savings. More details about utilizing two actuation stages for auto focusing at the camera device 215 are provided in relation to FIGS. 3 through 5.

In accordance with embodiments of the present disclosure, the camera device 215 can be packaged using a process presented in this disclosure. The process may populate different SMT components on a side of a first HDI tape substrate, and utilize one or more pillars within the first HDI tape substrate to make interconnections to a second HDI tape substrate. A transfer molding may be utilized to fill an encapsulant in between the first HDI tape substrate and the second HDI tape substrate. An image sensor may be positioned on the second HDI tape substrate (e.g., in a cavity of the second HDI tape substrate). Details about the process of packaging the camera device 215 are provided in relation to FIGS. 6 through 8B.

### Camera Device With Single Stage Autofocus

FIG. 3 is a cross section of a camera device 300 with single stage autofocus, in accordance with one or more embodiments. The camera device 300 may capture data (e.g., one or more images) of a local area surrounding an electronic wearable device that integrates the camera device 300.

The camera device 300 may include a lens barrel 304, a lens assembly 305, a shield case 310, an actuator assembly 315, a sensor 335, a printed circuit board (PCB) 340, an infrared cut-off filter (IRCF) 345, and an IRCF holder 350. In some embodiments, the camera device 300 may also include a controller (not shown in FIG. 3). In other embodiments, the controller may be part of some other system (e.g., a smartwatch the camera device 300 is coupled to). In alternative configurations, different and/or additional components may be included in the camera device 300. The camera device 300 is at an upward (vertical) posture that corresponds to a posture of the camera device 300 where an optical axis 302 of the lens assembly 305 is substantially parallel to gravity (e.g., parallel to y axis in FIG. 3). On the other hand, a forward (horizontal) posture of the camera device 300 would correspond to a posture of the camera device 300 where the optical axis 302 is substantially orthogonal to gravity (or parallel to x axis in FIG. 3).

The lens barrel 304 is a mechanical structure or housing for carrying one or more lenses of the lens assembly 305. The lens barrel 304 is a hollow structure with an opening on opposite ends of the lens barrel 304. The openings may provide a path for light (e.g., visible light, infrared light, etc.) to transmit between a local area and the sensor 335. Inside the lens barrel 304, one or more lenses of the lens assembly 305 are positioned between the two openings. The lens barrel 304 may be manufactured from a wide variety of materials ranging from plastic to metals. In some embodiments, one or more exterior surfaces of the lens barrel 304 are coated with a polymer (e.g., a sub-micron thick polymer). The lens barrel 304 may be rotationally symmetric about the optical axis 302.

The lens assembly 305 is a mechanical structure or housing for carrying one or more lenses. The lens assembly 305 is a hollow structure with an opening on opposite ends of the lens assembly 305. The openings may provide a path for light (e.g., visible light, infrared light, etc.) to transmit between a local area and the sensor 335. Inside the lens assembly 305, one or more lenses are positioned (e.g., in optical series) between the two openings. The lens assembly 305 may be manufactured from a wide variety of materials ranging from plastic to metals. In some embodiments, one or more exterior surfaces of the lens assembly 305 are coated with a polymer (e.g., a sub-micron thick polymer). The lens assembly 305 may be rotationally symmetric about the optical axis 302. The lens assembly 305 (and the one or more lenses in the lens assembly 305) may translate along the optical axis 302 (e.g., along y direction).

The shield case 310 may enclose some of the components of the camera device 300 as illustrated in FIG. 3. In other embodiments (not shown), the shield case 310 may enclose all of the components of the camera device 300. The shield case 310 may partially enclose the lens barrel 304. The shield case 310 may provide a space in which the lens barrel 304 can translate along the optical axis 302 and/or translate in a direction perpendicular to the optical axis 302. In some embodiments, the shield case 310 provides a space in which the lens barrel 304 rotates relative to one or more axes that are perpendicular to the optical axis 302. In some embodiments, the shield case 310 is rectangular shaped as illustrated. In alternative embodiments, the shield case 310 may be circular, square, hexagonal, or any other shape. In embodiments where the camera device 300 is part of another electronic device (e.g., a smartwatch), the shield case 310 may couple to (e.g., be mounted on, affixed to, attached to, etc.) another component of the electronic device, such as a frame of the electronic device. For example, the shield case 310 may be mounted on a watch body (e.g., the watch body 104) of the smartwatch. The shield case 310 may be manufactured from a wide variety of materials ranging from plastic to metals. In some examples, the shield case 310 is manufactured from a same material as the material of the electronic device the shield case 310 is coupled to such that the shield case 310 is not distinguishable from the rest of the electronic device. In some embodiments, the shield case 310 is manufactured from a material that provides a magnetic shield to surrounding components of the electronic device. In these embodiments, the shield case 310 may be a shield can. In some embodiments, one or more interior surfaces of the shield case 310 are coated with a polymer similar to the lens barrel 304 described above.

The actuator assembly 315 may cause a translation of the lens assembly 305 in a direction parallel to the optical axis 302 (e.g., along y direction). The actuator assembly 315 may provide an auto focus functionality for the camera device 300. The actuator assembly 315 may include an actuator 320, a carrier 325, and an auto focusing coil 330. One actuator assembly 315 may positioned at each side of the camera device 300 relative to the optical axis 302. Thus, the camera device 300 may include a pair of actuator assemblies 315, as shown in FIG. 3. The actuator assembly 315 may include more or fewer components.

The actuator 320 may be configured to provide auto focusing to the one or more lenses of the lens assembly 305. The actuator 320 may include, e.g., one or more voice coil motors (VCMs). The actuator 320 may enable (e.g., via VCM) a movement of the lens assembly 305 with the one or more lenses towards or away from the sensor 335 for auto focusing. To move the lens assembly 305 from an infinity focus position (i.e., far focal distance) to a macro focus position (i.e., close focal distance) that corresponds to an end-to-end stroke, the actuator 320 may cause translation of the one or more lenses in the lens assembly 305 along the optical axis 302 of, e.g., approximately 450 microns with a minimum end-to-end stroke of approximately 290 microns. For example, the actuator 320 may cause translation of the one or more lenses in the lens assembly 305 of at least approximately 40 microns in the negative direction along the optical axis 302 (i.e., toward the sensor 335) so that the lens assembly 305 moves from a neutral position to the infinity focus position. Furthermore, the actuator 320 may cause translation of the one or more lenses in the lens assembly 305 of at least, e.g., approximately 250 microns in the positive direction along the optical axis 302 (i.e., away from the sensor 335) so that the lens assembly 305 moves from the neutral position to a macro focus position. The neutral position is a position that the lens assembly 305 occupies along the optical axis 302 when no power is consumed by actuator 320 and the actuator assembly 315.

The actuator 320 may consume an auto focusing actuation power while providing auto focusing to the one or more lenses of the lens assembly 305, i.e., for causing translation of the one or more lenses of the lens assembly 305 along the optical axis 302. The auto focusing actuation power consumed by the actuator assembly 315 may be up to, e.g., 230 mW, mainly due to a relatively large current required to drive the actuator 320 (e.g., one or more VCMs). With additional power consumed at the camera device 300 for providing OIS functionality, a total power consumed at the camera device 300 for auto focusing and OIS functionalities could be substantial. Power consumed at the camera device 300 that is larger than a threshold power may cause a device temperature increase, and thus image quality reduction and/or device comfortability issue for a user. To reduce (and in some cases minimize) a level of the auto focusing actuation power consumption, relative positions of the lens assembly 305, the carrier 325 and the actuators 320 along the optical axis 302 may be controlled during assembling of the camera device 300.

The carrier 325 may be directly coupled to the lens barrel 304. For example, the carrier 325 comprises a first side in direct contact with a surface of the lens barrel 304 and a second side opposite the first side. In some embodiments, the carrier 325 is coupled to the lens barrel 304 by an adhesive. The auto focusing coil 330 may be affixed to the second side of the carrier 325. The carrier 325 may have a curvature that conforms to the curvature of the lens barrel 304. In some embodiments, more than one carrier 325 may be directly coupled to the lens barrel 304. In these embodiments, the number of carriers 325 may match a number of auto focusing coils 330 and the carriers 325 may be positioned at unique locations around the lens barrel 304 such that a carrier 325 is positioned between a corresponding auto focusing coil 330 and the lens barrel 304.

The auto focusing coil 330 may be configured to conduct electricity by being supplied with a current. The auto focusing coil 330 may be coupled to the actuator 320 and provide the current to the actuator 320. The auto focusing coil 330 may be positioned symmetrically about the optical axis 302. For example, the focusing coil 330 may consist of two individual coils positioned symmetrically about the optical axis 302, as illustrated in FIG. 3.

The sensor 335 may detect light received by the camera device 300 from the local area that passes through the one or more lenses of the lens assembly 305. The sensor 335 may also be referred to as an “image sensor.” The sensor 335 may be, e.g., a complementary metal oxide semiconductor (CMOS) sensor, a charge coupled device (CCD) sensor, some other device for detecting light, or some combination thereof. Data (e.g., images) captured by the sensor 335 may be provided to a controller or an image signal processor (not shown in FIG. 3). The sensor 335 may include one or more individual sensors, e.g., a photodetector, a CMOS sensor, a CCD sensor, a pixel, some other device for detecting light, or some combination thereof. The individual sensors may be in an array. The sensor 335 may capture visible light and/or infrared light from the local area. The visible and/or infrared light may be focused from the local area to the sensor 335 via the lens barrel 304. The sensor 335 may include various filters, such as the IRCF 345, one or more other color filters, a micro lens on each pixel of the sensor 335, some other device for filtering light, or some combination thereof. The IRCF 345 is a filter configured to block the infrared light and the ultraviolet light from the local area and propagate the visible light to the sensor 335. The IRCF 345 may be placed within the IRCF holder 350. The IRCF 345 together with the IRCF holder 350 may form an IRCF assembly.

The PCB 340 is a stationary component of the camera device 300 and provides mechanical support (e.g., by acting as a base) for the camera device 300. The PCB 340 may provide electrical connections for one or more components of the camera device 300. The PCB 340 may be positioned below the sensor 335 along the optical axis 302. In some embodiments, a controller may be located on the PCB 340 and the PCB 340 electrically connects the controller to various components (e.g., the auto focusing coil 330, the sensor 335, IRCF 345, etc.) of the camera device 300.

### Camera Device With Two Stage Autofocus

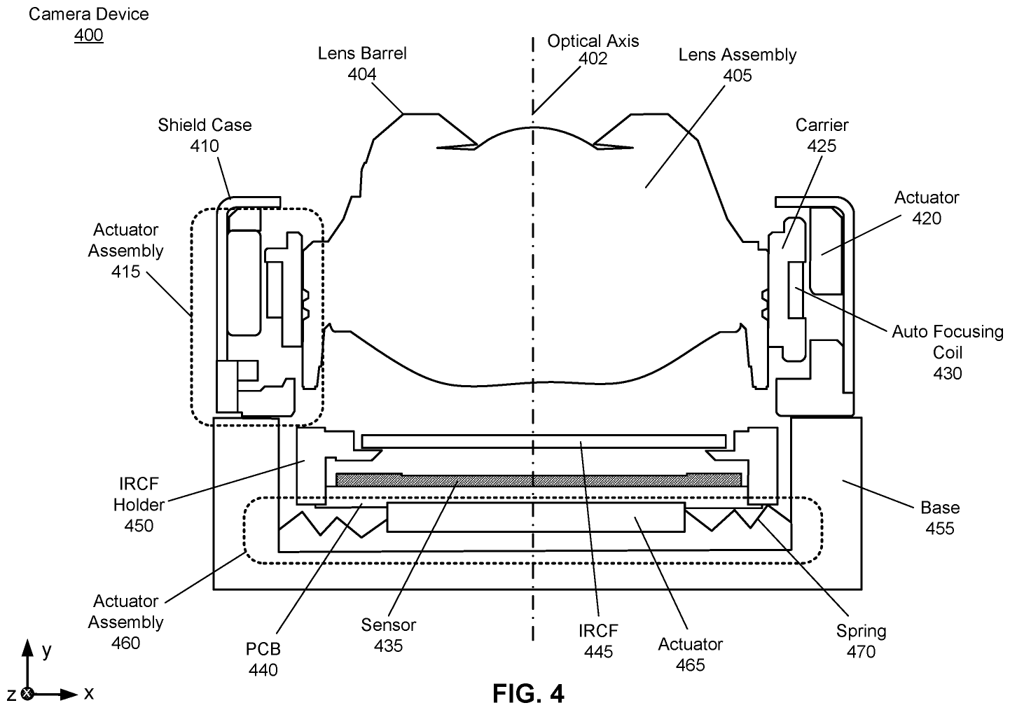

FIG. 4 is a cross section of a camera device 400 with two stage autofocus, in accordance with one or more embodiments. The camera device 400 may capture data (e.g., one or more images) of a local area surrounding an electronic wearable device that integrates the camera device 400.

The camera device 400 may include a lens barrel 404, a lens assembly 405, a shield case 410, an actuator assembly 415, a sensor 435, a PCB 440, an IRCF 445, an IRCF holder 450, a base 455, and an actuator assembly 460. In some embodiments, the camera device 400 may also include a controller (not shown in FIG. 4). In other embodiments, the controller may be part of some other system (e.g., a smartwatch the camera device 400 is coupled to). In alternative configurations, different and/or additional components may be included in the camera device 400. The camera device 400 is at an upward (vertical) posture that corresponds to a posture of the camera device 400 where an optical axis 402 of the lens assembly 405 is substantially parallel to gravity (e.g., parallel to y axis in FIG. 4). On the other hand, a forward (horizontal) posture of the camera device 400 would correspond to a posture of the camera device 400 where the optical axis 402 is substantially orthogonal to gravity (or parallel to x axis in FIG. 4). Each of the lens barrel 404, the lens assembly 405, the shield case 410, the sensor 435, the PCB 440, the IRCF 445, and the IRCF holder 450 operates in the substantially same manner as a corresponding component of the camera device 300.

The actuator assembly 415 may cause a translation of the lens assembly 405 in a direction parallel to the optical axis 402 (e.g., along y direction). The actuator assembly 415 may provide an auto focus functionality for the camera device 400. The actuator assembly 415 may include an actuator 420, a carrier 425, and an auto focusing coil 430. One actuator assembly 415 may be positioned at each side of the camera device 400 relative to the optical axis 402. Thus, the camera device 400 may include a pair of actuator assemblies 415, as shown in FIG. 4. The actuator assembly 415 may include more or fewer components. Each of the actuator 420, the carrier 425, and the auto focusing coil 430 may be implemented in the substantially same manner as a corresponding component of the actuator assembly 315 of the camera device 300.

The actuator assembly 415 may include, e.g., one or more VCMs. The actuator assembly 415 may be configured to translate the lens assembly 405 over a first range along the optical axis 402. Power consumed by the actuator assembly 415 may increase with a distance the lens assembly 405 is actuated from a neutral position of the lens assembly 405. The neutral position is a position in which the lens assembly 405 sits when no power is applied to the one or more VCMs in the actuator assembly 415. In some embodiments, the first range of translation of the lens assembly 405 is approximately 130 microns in the positive direction along the optical axis 402 so that the lens assembly 405 moves away from the sensor 435 from the neutral position to a macro focus position, and approximately 40 microns in the negative direction along the optical axis 402 so that the lens assembly 405 moves toward the sensor 435 from the neutral position to an infinity focus position. In other embodiments, the first range of translation of the lens assembly 405 is approximately 85 microns in the positive direction along the optical axis 402 so that the lens assembly 405 moves away from the sensor 435 from the neutral position to a macro focus position, and approximately 85 microns in the negative direction along the optical axis 402 so that the lens assembly 405 moves toward the sensor 435 from the neutral position to an infinity focus position. In other embodiments, the first range of translation of the lens assembly 405 is over some other range.

The actuator assembly 460 may be configured to translate the sensor 435 along the optical axis 402. The actuator assembly 460 may be further configured to translate the sensor 435 along one or more directions perpendicular to the optical axis 402. The actuator assembly 460 may provide an auto focus functionality and OIS functionality for the camera device 400. The actuator assembly 460 may include an actuator 465 and one or more springs 470. The actuator assembly 460 may include one or more additional components not shown in FIG. 4.

The actuator 465 may be implemented as, e.g., a shape memory alloys (SMA), a microelectromechanical system (MEMS), or some other type of actuator. The actuator 465 may couple to (e.g., be mounted on, affixed to, attached to, etc.) the sensor 335 via the PCB 440. The actuator 465 may be further connected to the base 455 via the one or more springs 470. The springs 470 may be positioned symmetrically about the optical axis 402. For example, the actuator assembly 460 may comprise two individual springs 470 positioned symmetrically about the optical axis 402, as illustrated in FIG. 4. The springs 470 may facilitate actuation in order to translate the sensor 435 along a direction parallel to the optical axis 402 (e.g., along y axis) for auto focusing functionality, and/or along one or more directions orthogonal to the optical axis 402 (e.g., along x axis and/or z axis) for OIS functionality.

The actuator assembly 460 may be configured to translate the sensor 435 over a second range along the optical axis 402. The actuator assembly 460 may be more power efficient than the actuator assembly 415, i.e., the actuator assembly 460 may require less power to translate the sensor 435 along the optical axis 402 than the actuator assembly 415 for translating the lens assembly 405 over a same distance (i.e., for the same stroke). In some embodiments, the second range of translation of the sensor 435 is approximately 80 microns in the positive direction along the optical axis 402 so that the sensor 435 moves toward the lens assembly 405 from a neutral position to an infinity focus position. The neutral position of the sensor 435 may be a position in which the sensor 435 sits when no power is applied to actuate the actuator assembly 460. In other embodiments, the second range of translation of the sensor 435 along the optical axis 402 may be over some other distance.

Note that actuator assembly 460 may not need to be actuated in order to position the sensor 435 into a macro focus position, i.e., the neutral position of the sensor 435 may correspond to the macro focus position. Thus, the actuator assembly 460 may be primarily employed to control the infinity focus position via translation of the sensor 435 along the optical axis 402, whereas the actuator assembly 415 may be primarily employed to control the macro focus position via translation of the lens assembly 405 along the optical axis 402. In some embodiments, the actuator assembly 460 may also be configured to perform OIS. In such cases, the actuator assembly 460 may be configured to translate the sensor 435 in one or more directions that are orthogonal to the optical axis 402.

Note that the camera device 400 may focus over a range of distances, and generally is bounded by a close focal distance (i.e., close focus, macro focus, or macro mode) and a far focal distance (i.e., far focus, infinity focus, or infinity mode). At the close focal distance (i.e., at macro focus), the lens assembly 405 may be at its farthest from the sensor 435, and in contrast, at infinity focus, the lens assembly 405 may be closest to the sensor 435. Note that VCMs in conventional AF cameras use a lot of energy for large actuation distances (e.g., 400 microns) in order to facilitate a close focal distance. In contrast, the two actuation stages of the camera device 400 are more power efficient than the single VCM stage used in conventional designs. The efficiency stems from using the power efficient second stage (i.e., the actuator assembly 460) to translate the sensor 435 closer/farther from the lens assembly 405 in order to reduce the full range of actuation of the lens assembly 405 via the actuator assembly 415. Moreover, the first range of translation of the actuator assembly 415 and the second range of translation of the actuator assembly 460 may be selected to, e.g., optimize total power consumed at the camera device 400, or optimizing power to reach a close focal distance. For example, while keeping the same power requirements for infinity focus, the power consumed at the camera device 400 for achieving macro focus may be smaller by approximately 73% relative to the macro focus power consumed at the camera device 300. When optimizing the total consumed power, the maximum consumed power at the camera device 400 may be smaller by up to approximately 89.5% relative to the total power consumed at the camera device 300.

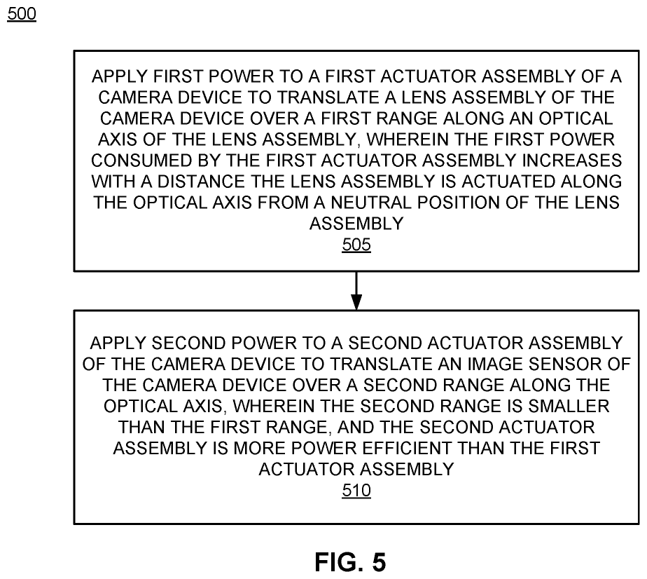

FIG. 5 is a flowchart illustrating a process 500 of operating a camera device with two stage autofocus. Steps of the process 500 may be performed by one or more components of the camera device (e.g., the camera device 400). The camera device may be capable of being part of a smartwatch or some other wearable electronic device. Embodiments may include different and/or additional steps of the process 500, or perform the steps of the process 500 in different orders.

The camera device applies 505 first power to a first actuator assembly to translate a lens assembly of the camera device over a first range along an optical axis of the lens assembly, wherein the first power consumed by the first actuator assembly increases with a distance the lens assembly is actuated along the optical axis from a neutral position of the lens assembly. The neutral position may be a position of the lens assembly along the optical axis when no power is consumed by the first actuator assembly. The first actuator assembly may comprise one or more VCMs. The optical axis may be parallel to gravity when the camera device is at a first orientation (e.g., vertical orientation), and the optical axis is orthogonal to gravity when the camera device is at a second orientation (e.g., horizontal orientation).

The camera device applies 510 second power to a second actuator assembly of the camera device to translate an image sensor of the camera device over a second range along the optical axis, wherein the second range is smaller than the first range, and the second actuator assembly is more power efficient than the first actuator assembly. The second power consumed by the second actuator assembly may increase with a second distance the image sensor is actuated along the optical axis from a second neutral position of the image sensor. The second neutral position may be a position of the image sensor along the optical axis when no power is consumed by the second actuator assembly. The camera device may adjust a distance between the lens assembly and the image sensor along the optical axis by at least one of the first actuator assembly and the second actuator assembly to select a focal plane of the camera device. The camera device may apply third power to the second actuator assembly to translate the image sensor in one or more directions orthogonal to the optical axis. The second actuator assembly may comprise at least one SMA or at least one MEMS.

### Camera Device Packaging Process

Embodiments of the present disclosure are further directed to a process of packaging a camera device for integration into a wearable device (e.g., smartwatch, headset, etc.). The packaging process presented herein utilizes a sandwich molding technique. FIG. 6 illustrates an example process 600 of packaging a camera device, in accordance with one or more embodiments. The camera device packaged via the process 600 may be an embodiment of the camera device 115A, the camera device 115B, and/or the camera device 215. The process 600 may include additional or fewer steps than what is shown in FIG. 6. The process 600 may utilize at least two HDI tape substrates. Each of the HDI tape substrates used in the process 600 may be very thin HDI tape substrates, which facilitates a small form factor of the camera device.

At 602, multiple SMT components may be placed on a first HDI tape substrate (e.g., bare bottom substrate). The SMT components (e.g., gyros, electrically erasable programmable read-only memory (EEPROM), controller, resistors, capacitors, etc.) may be populated inside a surface of the first HDI tape substrate. At 604, one or more copper pillars may be attached to the first HDI tape substrate. The one or more copper pillars may be utilized to reflow within a perimeter area of the first HDI tape substrate to make interconnection to a second HDI tape substrate (e.g., top substrate). At 606, the second HDI tape substrate may be attached to the one or more copper pillars. At 608, a transfer molding may be applied in between the first and second HDI tape substrates. A sandwich transfer molding technique may be used to fill an encapsulant in between the first HDI tape substrate and the second HDI tape substrate.

At 610, a die may be attached (i.e., bonded) to the second HDI tape substrate (e.g., top substrate). At 612, the epoxy curing of the attached die may be performed to improve bonding. At 614, the wire bonding may be applied onto the cured die. At 616, a lens holder may be attached onto the die. At 618, the epoxy curing for the attached lens holder may be performed to improve bonding of the lens. At 620, the singulation (i.e., dicing) is performed to divide a wafer into individual chips. At 622, the active alignment process may be performed. At 624 the thermal curing may be performed. Finally, at 626, the soldering of a VCM may be applied. The process 600 for packaging of the camera device may provide a platform to embed various discrete SMT components inside the HDI tape substrates with flatness and rigidity. Moreover, the process 600 may allow SMT components to be stacked on top for vertical integration (i.e., three-dimensional integration).

There are several benefits of the camera packaging process 600 presented herein. Various discrete components such as EEPROM, controller, gyros, etc. may be placed inside the camera device. By integrating the discrete components inside the camera device, the cost of additional flexible substrate is avoided, and the overall manufacturing cost is reduced. The overall size of the camera device is reduced while achieving a clean module look with less substrate bending in the camera system. With close proximity of the image sensor, shorter signal routing can be achieved. By utilizing the transfer molding, better rigidity and support for the camera device can be achieved, as well as a smaller substrate surface area which is beneficial for efficient signal routing (e.g., by using anisotropic conductive film). The process 600 represents a unique way to package all components inside a camera device for a new complete look and easier handling and transferring on the system level assembly. The process 600 may provide a much better yield and be cheaper in total bills of material (BOM) and assembly cost in comparison to the traditional embedded PCB substrate technology.

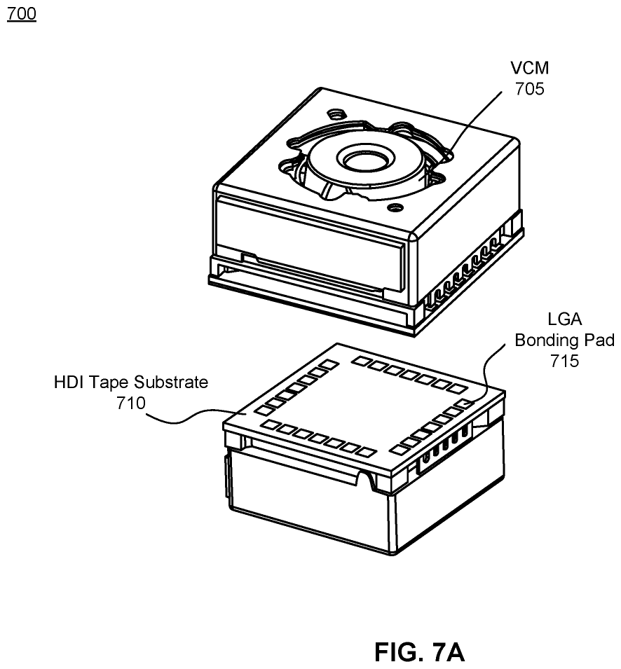

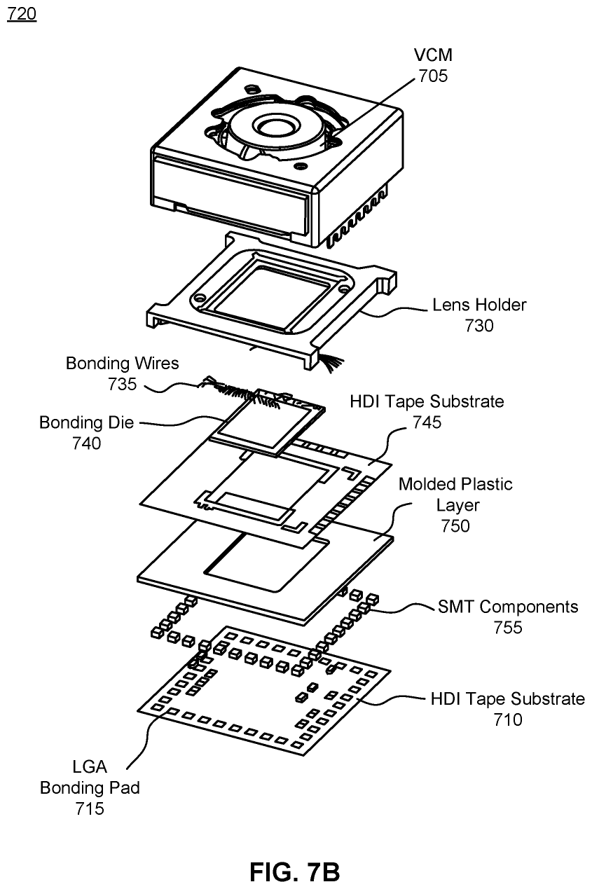

FIG. 7A illustrates an example expanded view 700 of the camera device packaged using the process 600. The camera device illustrated in FIG. 7A may include, among other components, a VCM 705, and a HDI tape substrate 710 with a land grid array (LGA) bonding pad 715. The camera device illustrated in FIG. 7A may include additional components not shown in FIG. 7A (e.g., as shown in FIG. 7B). The camera device illustrated in FIG. 7A may be an embodiment of the camera device 115A, the camera device 115B, and/or the camera device 215.

The VCM 705 may provide autofocus during image capture. The VCM 705 may include voice coil actuators that consist of a single-pole permanent magnet and a copper coil. The VCM 705 is a two-lead, single phase motor that does not require commutation, resulting in simple but effective autofocusing operation. The HDI tape substrate 710 may represent a bottom substrate of the camera device. As shown in FIG. 7A, the HDI tape substrate 710 may include the LGA bonding pad 715 for coupling various components to a top surface of the HDI tape substrate 710. More details about coupling the various components to the top surface of the HDI tape substrate 710 are provided below in relation to FIG. 7B.

FIG. 7B illustrates an example expanded view 720 of the camera device packaged using the process 600. As shown in FIG. 7B, in addition to the VCM 705 and the HDI tape substrate 710 (i.e., bottom surface) previously shown in FIG. 7A, the camera device may include a lens holder 730, a HDI tape substrate 745 (i.e., top substrate), a molded plastic layer 750, and SMT components 755. The camera device illustrated in FIG. 7B may include additional components not shown in FIG. 7B. The camera device illustrated in FIG. 7B may be an embodiment of the camera device 115A, the camera device 115B, and/or the camera device 215.

The lens holder 730 is a mechanical structure configured to hold a lens assembly. The lens holder 730 functions to couple the lens assembly to the HDI tape substrate 745. The lens holder 730 may include an aperture through which light from the lens assembly passes toward the image sensor. In some embodiments, the aperture of the lens holder 730 includes various filters, such as an IRCF for blocking infrared light from the local area and propagate the visible light to the image sensor. The lens assembly held by the lens holder 730 represents a mechanical structure or housing for carrying one or more lenses. The lens assembly is a hollow structure with an opening on opposite ends of the lens assembly. The openings may provide a path for light (e.g., visible light, infrared light, etc.) to transmit between a local area and an image sensor of the camera device. Inside the lens assembly, one or more lenses may be positioned between the two openings. The lens assembly held by the lens holder 730 may be manufactured from a wide variety of materials ranging from plastic to metals. In some embodiments, one or more exterior surfaces of the lens assembly are coated with a polymer (e.g., a sub-micron thick polymer). The lens assembly held by the lens holder 730 may be rotationally symmetric about an optical axis of the one or more lenses of the lens assembly. In some embodiments, the lens assembly held by the lens holder 730 includes one or more actuators (e.g., VCM, SMA, MEMS, etc.) that translate one or more of the lenses along their optical axis to provide auto focus capability.

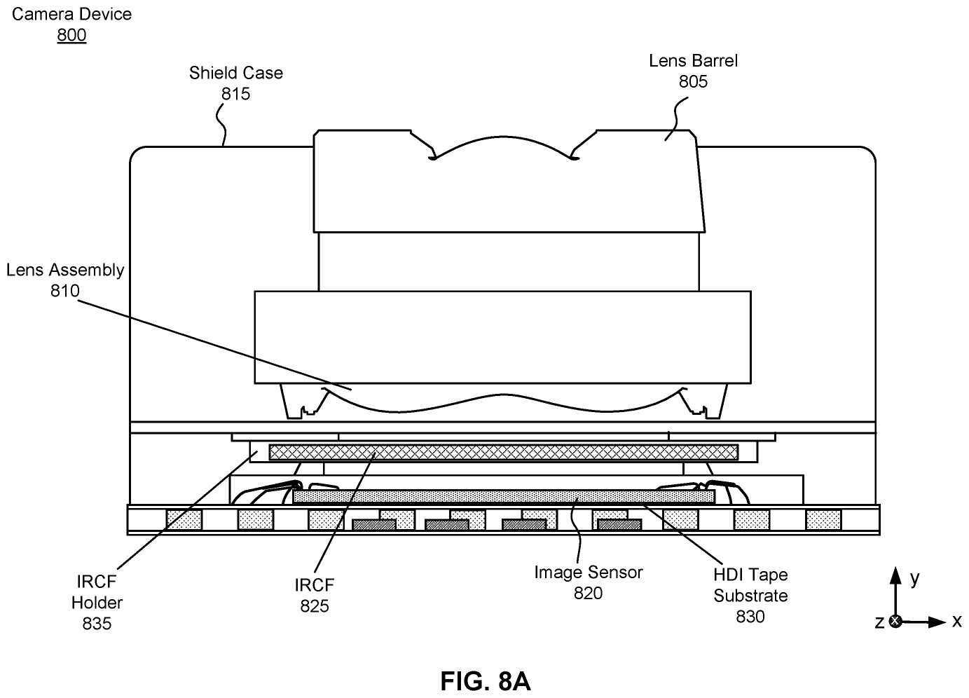

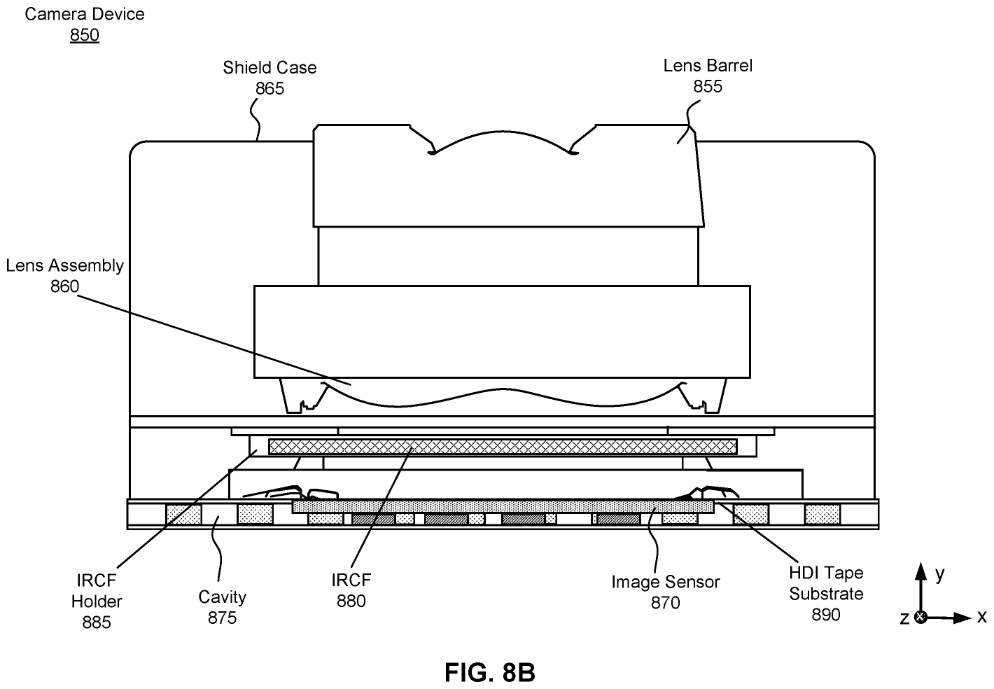

The HDI tape substrate 745 may represent a top substrate of the camera device. A top surface of the HDI tape substrate 745 may be coupled to the lens holder 730. In some embodiments, the HDI tape substrate 745 is formed such that the HDI tape substrate 745 includes a cavity within which the image sensor is located (e.g., as shown in FIG. 8B). In other embodiments, the image sensor is located on the top surface of the HDI tape substrate 745 (e.g., as shown in FIG. 8A). The HDI tape substrate 745 may include a plurality of electrodes, and at least some of the electrodes (e.g., data pathways, power, ground, etc.) may be coupled to the image sensor. Wires 735 and a die 740 (e.g., for integration of the image sensor) may be bonded onto the top surface of the HDI tape substrate 745.

As shown in FIG. 7B, the HDI tape substrate 710 may be coupled to a plurality of SMT components 755 mounted on the top surface of the HDI tape substrate 710, e.g., via the LGA bonding pad 715. The SMT components 755 may be, e.g., capacitors, resistors, EPROMs, etc. The HDI tape substrate 710 may include a plurality of electrodes, at least some of which are connected to the SMT components 755. One or more electrodes of the HDI tape substrate 710 may be also connected to one or more other components outside of the camera device (e.g., for data readout). Additionally, a plurality of pillars (not shown in FIG. 7B) may be mounted to the top surface of the HDI tape substrate 710. The pillars may be, e.g., positioned along a periphery of the top surface of the HDI tape substrate 710. At least some of the pillars may be connected to one or more electrodes of the HDI tape substrate 710. In some embodiments, one or more of the pillars are dummy pillars whose purpose is to provide structural support for the camera device.

The molded plastic layer 750 may be sandwiched between a bottom surface of the HDI tape substrate 745 and the top surface of the HDI tape substrate 710. The molded plastic layer 750 may include one or more vias to interconnect at least one electrode of the HDI tape substrate 745 to at least one electrode of the HDI tape substrate 710. In some embodiments, the one or more vias are the pillars that are connected to one or more electrodes of the HDI tape substrate 710. The pillars may connect to corresponding electrodes of the HDI tape substrate 745. In this manner, continuous circuits can be formed between the image sensor and the SMT components 755 on the HDI tape substrate 710, and other components outside of the camera device.

Although FIG. 7B illustrates a single molded plastic layer 750 placed between the HDI tape substrate 745 and the HDI tape substrate 710, in other embodiments, one or more additional HDI tape substrates and molded plastic layers may be added in a vertical stack. For example, there may be a third HDI tape substrate with a second molded plastic layer between the third HDI tape substrate and the HDI tape substrate 710. In this manner, additional components may be vertically integrated into the camera device.

FIG. 8A is a cross section of an example structure of a camera device 800 with an image sensor 820 located on a top surface of a HDI tape substrate 830, in accordance with one or more embodiments. The camera device 800 may be packaged into a wearable device (e.g., headset, smartwatch, etc.) using the process 600. The camera device 800 may be an embodiment of the camera device 115A, the camera device 115B, and/or the camera device 215. The HDI tape substrate 830 may represent a top substrate of the camera device 800. The HDI tape substrate 830 may be an embodiment of the HDI tape substrate 745. In addition to the image sensor 820 and the HDI tape substrate 830, the camera device 800 includes a lens barrel 805, a lens assembly 810, a shield case 815, an IRCF 825, and an IRCF holder 835. In alternative configurations, different and/or additional components may be included in the camera device 800. For example, in some embodiments, the camera device 800 may include a controller (not shown in FIG. 8A). In alternative embodiments, the controller may be part of some other system (e.g., a wearable device the camera device 800 is integrated into).

The camera device 800 may be configured to have both a focusing assembly and a stabilization assembly (not shown in FIG. 8A). The focusing assembly is configured to cause a translation of the lens barrel 805 in a direction parallel to an optical axis of the lens assembly 810. The focusing assembly may provide an auto focus functionality for the camera device 800. The stabilization assembly may be configured to cause a translation of the lens barrel 805 in one or more directions perpendicular to the optical axis of the lens assembly 810. The stabilization assembly may provide an OIS functionality for the camera device 800 by stabilizing an image projected through the lens barrel 805 to the image sensor 820.

The lens barrel 805 is a mechanical structure or housing for carrying one or more lenses of the lens assembly 810. The lens barrel 805 is a hollow structure with an opening on opposite ends of the lens barrel 805. The openings may provide a path for light (e.g., visible light, infrared light, etc.) to transmit between a local area and the image sensor 820. Inside the lens barrel 805, one or more lenses of the lens assembly 810 are positioned between the two openings. The lens barrel 805 may be manufactured from a wide variety of materials ranging from plastic to metals. In some embodiments, one or more exterior surfaces of the lens barrel 805 are coated with a polymer (e.g., a sub-micron thick polymer). The lens barrel 805 may be rotationally symmetric about the optical axis of the lens assembly 810.

The shield case 815 may enclose some of the components of the camera device 800 as illustrated in FIG. 8A. In other embodiments (not shown), the shield case 815 encloses all of the components of the camera device 800. As illustrated in FIG. 8A, the shield case 815 partially encloses the lens barrel 805. The shield case 815 provides a space in which the lens barrel 805 can translate along the optical axis of the lens assembly 810 and/or translate in a direction perpendicular to the optical axis of the lens assembly 810. In some embodiments, the shield case 815 provides a space in which the lens barrel 805 rotates relative to one or more axes that are perpendicular to the optical axis of the lens assembly 810. In some embodiments, the shield case 815 may be rectangular-shaped. In alternative embodiments, the shield case 815 may be circular, square, hexagonal, or any other shape. In embodiments where the camera device 800 is part of a wearable device (e.g., headset, smartwatch), the shield case 815 may couple to (e.g., be mounted on, affixed to, attached to, etc.) another component of the wearable device, such as a frame of the wearable device. For example, the shield case 815 may be mounted on a frame of the headset. The shield case 815 may be manufactured from a wide variety of materials ranging from plastic to metals. In some examples, the shield case 815 is manufactured from a same material as the material of the wearable device the shield case 815 is coupled to such that the shield case 815 is not distinguishable from the rest of the wearable device. In some embodiments, the shield case 815 is manufactured from a material that provides a magnetic shield to surrounding components of the electronic device. In these embodiments, the shield case 815 may be a shield can. In some embodiments, one or more interior surfaces of the shield case 815 are coated with a polymer similar to the lens barrel 805 described above.

The image sensor 820 captures data (e.g., one or more images) describing a local area. The image sensor 820 may include one or more individual sensors, e.g., a photodetector, a complementary metal-oxide semiconductor (CMOS) sensor, a charge-coupled device (CCD) sensor, some other device for detecting light, or some combination thereof. The individual sensors may be in an array. For the camera device 800 integrated into a wearable device, the local area is an area surrounding the wearable device. The image sensor 820 captures light from the local area. The image sensor 820 may capture visible light and/or infrared light from the local area surrounding the electronic device. The visible and/or infrared light is focused from the local area to the image sensor 820 via the lens barrel 805. The image sensor 820 may include various filters, such as the IRCF 825. The IRCF 825 is a filter configured to block the infrared light from the local area and propagate the visible light to the image sensor 820. The IRCF 825 may be placed within the IRCF holder 835. As shown in FIG. 8A, the image sensor 820 may be located on top of the HDI tape substrate 830. In some embodiments (not shown), a controller (e.g., with one or more processors) may be further located on the HDI tape substrate 830 and the HDI tape substrate 830 electrically connects the controller to various components of the camera device 800. In other embodiments (not shown), the controller is in a different location within the camera device 800 or external to the camera device 800.

FIG. 8B is a cross section of an example structure of a camera device 850 with an image sensor 870 located within a cavity 875 of a HDI tape substrate 890, in accordance with one or more embodiments. The camera device 850 may be packaged into a wearable device (e.g., headset, smartwatch, etc.) using the process 600. The camera device 850 may be an embodiment of the camera device 115A, the camera device 115B, and/or the camera device 215. The HDI tape substrate 890 may represent a top substrate of the camera device 850. The HDI tape substrate 890 may be an embodiment of the HDI tape substrate 745. In addition to the image sensor 870 and the HDI tape substrate 890, the camera device 850 includes a lens barrel 855, a lens assembly 860, a shield case 865, an IRCF 880, and an IRCF holder 885. In alternative configurations, different and/or additional components may be included in the camera device 850. Each component of the camera device 850 operates in the substantially same manner as a corresponding component of the camera device 800. In comparison with packaging of the camera device 800, during the process 600 of packaging the camera device 850, the cavity 875 may be formed within the HDI tape substrate 890 for placing the image sensor 870 in between top and bottom surfaces of the HDI tape substrate 890.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A camera device comprising:
a lens assembly configured to translate along an optical axis;
an image sensor;
a first actuator assembly configured to translate the lens assembly over a first range along the optical axis, wherein power consumed by the first actuator assembly increases with a distance the lens assembly is actuated along the optical axis from a neutral position of the lens assembly; and
a second actuator assembly configured to translate the image sensor over a second range along the optical axis, wherein the second range is smaller than the first range.

2. The camera device of claim 1, wherein the second actuator assembly is more power efficient than the first actuator assembly.

3. The camera device of claim 1, wherein a distance between the lens assembly and the image sensor along the optical axis is adjusted by at least one of the first actuator assembly and the second actuator assembly to select a focal plane of the camera device.

4. The camera device of claim 1, wherein the neutral position is a position of the lens assembly along the optical axis when no power is consumed by the first actuator assembly.

5. The camera device of claim 1, wherein:
the first actuator assembly comprises one or more voice coil motors (VCMs); and
the second actuator assembly comprises at least one shape memory alloy (SMA) or at least one microelectromechanical system (MEMS).

6. The camera device of claim 1, wherein power consumed by the second actuator assembly increases with a second distance the image sensor is actuated along the optical axis from a second neutral position of the image sensor, and the second neutral position is a position of the image sensor along the optical axis when no power is consumed by the second actuator assembly.

7. The camera device of claim 1, wherein the second actuator assembly is further configured to translate the image sensor in one or more directions orthogonal to the optical axis.

8. The camera device of claim 1, wherein the optical axis is parallel to gravity when the camera device is at a first orientation, and the optical axis is orthogonal to gravity when the camera device is at a second orientation.

9. The camera device of claim 1, wherein the camera device is capable of being part of a wearable electronic device.

10. A method comprising:
applying first power to a first actuator assembly of a camera device to translate a lens assembly of the camera device over a first range along an optical axis of the lens assembly, wherein the first power consumed by the first actuator assembly increases with a distance the lens assembly is actuated along the optical axis from a neutral position of the lens assembly; and
applying second power to a second actuator assembly of the camera device to translate an image sensor of the camera device over a second range along the optical axis, wherein the second range is smaller than the first range, and the second actuator assembly is more power efficient than the first actuator assembly.

11. The method of claim 10, further comprising:
adjusting a distance between the lens assembly and the image sensor along the optical axis by at least one of the first actuator assembly and the second actuator assembly to select a focal plane of the camera device.

12. The method of claim 10, further comprising:
applying third power to the second actuator assembly to translate the image sensor in one or more directions orthogonal to the optical axis.

13. A camera device comprising:
an image sensor;
a lens assembly configured to hold at least one lens;
a first high density interconnect (HDI) tape substrate having a top surface and a bottom surface, the top surface of the first HDI tape substrate coupled to the lens assembly, the first HDI tape substrate coupled to the image sensor, the first HDI tape substrate including a first plurality of electrodes;
a second HDI tape substrate including a second plurality of electrodes and a plurality of components mounted on a top surface of the second HDI tape substrate; and
a molded plastic layer sandwiched between the bottom surface of the first HDI tape substrate and the top surface of the second HDI tape substrate, the molded plastic layer including one or more vias to interconnect at least one electrode of the first plurality of electrodes to at least one electrode of the second plurality of electrodes.

14. The camera device of claim 13, wherein the first HDI tape substrate includes a cavity within which the image sensor is located.

15. The camera device of claim 13, wherein the image sensor is located on the top surface of the first HDI tape substrate.

16. The camera device of claim 13, wherein:
one or more electrodes of the first plurality of electrodes are coupled to the image sensor; and
one or more electrodes of the second plurality of electrodes are connected to the plurality of components.

17. The camera device of claim 13, further comprising:
one or more pillars mounted to the top surface of the second HDI tape substrate.

18. The camera device of claim 17, wherein the one or more pillars are positioned along a periphery of the top surface of the second HDI tape substrate.

19. The camera device of claim 17, wherein at least one pillar of the one or more pillars is connected to at least one electrode of the second plurality of electrodes.

20. The camera device of claim 17, wherein the one or more pillars comprise the one or more vias connected to one or more electrodes of the second plurality of electrodes.
